(19) United States
(12) Patent Application Publication
(10) Pub. No.: US 2003/0097755 A1
(43) Pub. Date: May 29, 2003

(54) Bi-directional instrument for shaving or cutting hair

(76) Inventor: Ronald Arun Singh, Salinas, CA (US)

Correspondence Address: Ronald Arun Singh, 364 Greenwich Way, Salinas, CA, 93907, US

(21) Appl. No.: 10/282,509

(22) Filed: Oct. 28, 2002

Related U.S. Application Data
(63) Continuation-in-part of application No. 09/660,731, filed on Sep. 13, 2000, now abandoned.

(51) Int. Cl. B26B 21/00

(52) U.S. Cl. 30/34.1; 30/50

(57) ABSTRACT

A safety razor has a head holding a conventional interchangeable blade system, a first friction pivot at the head to a first end of a first handle, and a second friction pivot at a second end of the first handle opposite the first end to one end of a second handle. The razor is characterized in that, with the second handle as a handle for holding the razor in use, the head may be both angled and offset relative to the second handle. The first handle is preferably implemented with a fixed angle of from fifteen to ninety degrees, preferably about forty-five degrees.

### CROSS-REFERENCE TO RELATED DOCUMENTS

The present application is a continuation-in-part of application Ser. No. 09/660,731 filed on Sep. 13, 2000.

### FIELD OF THE INVENTION

This invention is in the field of shaving instruments, and has particular application in providing an improved method and apparatus for manual bi-directional shaving or cutting of hair.

### BACKGROUND OF THE INVENTION

Keen-edged cutting implements for shaving or cutting hair first originating in the form of clam shells, shark's teeth, or sharpened flints as first used by human civilizations of prehistoric times. Both apparatus and methods have changed dramatically through many centuries of development and evolution. Simple solid metal cutting implements made of gold or copper were developed by later civilizations, soon evolving into razors with ornamental handles and individually hollow-ground blades crafted of crucible steel in the 18th and 19th centuries A.D. Soon after, a forerunner of the modern safety razor was developed; a hoe-shaped implement having a steel blade with a guard along one edge to protect the skin from nicks and cuts during shaving. The safety razor gained wide popularity with later development and improvement by combining the hoe-shaped implement with a replaceable stainless steel blade having a cutting edge on both opposite edges; the double-edged razor. An important advantage offered by this configuration is that, while shaving, a user has an ability to switch from a downward stroke to an upward stroke, often without releasing the grip on the handle of the razor. In most cases a substantial change in the position of the wrist and the arm is required to accomplish the change in stroke direction. Another key advantage provided by this type of razor is that by alternating the use of both cutting edges during shaving, a user extends the longevity of the blade itself, thereby lowering the cost of use. The double-edged stainless steel blade is easily replaceable, inexpensive to manufacture, and of a size standard in the industry allowing for universal use in a variety of safety razors from many different manufacturers.

The popularity of the replaceable double-edged blade was later eclipsed by the development of inexpensive cartridge-style injector blades, designed to fit into disposable plastic handles. The original cartridge was developed having only one cutting edge, but many manufacturers now produce a version having two separate cutting blades, each with the cutting edge positioned one above the other, on the same side of the cartridge (single direction). The two principle parts of a razor of this type; the cartridge containing the cutting blade or blades, and the handle, can be manufactured separately allowing a user to replace the cartridge as needed using only one handle. In some cases the head, cartridge and handle of the razor are manufactured as an integral part of each other providing a completely disposable razor.

There are currently many types of cartridge-style razors such as described above, varying greatly in cost, method of manufacture, composition and appearance. One attribute that is still common to all such razors, however is the cutting edge of the blade or blades is located on only one side of the cartridge or head of the razor. Many users, particularly those wishing to shave hairs under and along the jaw line of the face, on the legs or under the arms, prefer to shave using both downward and upward strokes, alternating between them as desired. Much time can be saved by shaving in this manner, and in most cases an upward stroke running against the natural downward growth direction of the hairs being cut, allows a user to obtain a much closer shave. Hairs being cut against the direction of growth in this manner will tend to stand up once contact with the cutting edge occurs, allowing for the hair to be cut at a point much closer to the skin.

As previously mentioned, the cutting edge of the blade or blades of a current shaving implement is typically located on only one side of the cartridge or head of the razor, posing a significant problem for a user wishing to obtain a closer shave by cutting hairs using a stroke in a direction against the hair's natural growth. For example, facial hairs, particularly those growing along or under the jaw line and on the neck, or hairs on the legs or under the arms, typically grow in a downward direction. In order for a user to achieve the desired stroke against the growth direction, the user's grip on the handle must be released and the razor rotated 180 degrees opposite to that of a typical downward stroke. Once the grip is repositioned, the user's wrist must be significantly bent to allow for the correct angle, approximately 30 degrees, between the direction of the cutting edge of the razor and the skin surface when performing the desired opposite stroke. This process is cumbersome for users, particularly when shaving facial, leg or armpit hairs.

What is clearly needed is a method and apparatus for shaving or cutting hair, allowing a user to easily achieve contiguous strokes at the proper angle in two opposite directions without the need for changing the grip on the handle of the razor, or changing or holding the wrist and arm at an extreme and uncomfortable angle. In embodiments described in enabling detail below, such a razor is taught having the cutting edge on opposite sides of the head, angled so as to allow the user to easily achieve the correct cutting angle between the cutting edge and the surface to be shaved, regardless of the stroke direction used, thereby allowing the user to shave bi-directionally, easily and with comfort, and with an adjustment system that allows the head to be both rotated and offset relative to a principle handle, being the handle by which the razor is held in use.

### SUMMARY OF THE INVENTION

Ina preferred embodiment of the present invention a safety razor is provided comprising a head holding a blade system, a first friction pivot at the head to a first end of a first handle, and a second friction pivot at a second end of the first handle opposite the first end to one end of a second handle. The razor is characterized in that, with the second handle as a handle for holding the razor in use, the head may be both angled and offset relative to the second handle.

In a preferred embodiment the head is configured to accept interchangeable blade modules of any number of blades facing in either one or opposite directions. Also in a preferred embodiment the first handle has a first part with a first axis and a second part with a second axis, and the first and second axes form a fixed angle. The angle may be from 15 and 60 degrees inclusively in various embodiments, but is not adjustable in one embodiment. In preferred embodiments the fixed angle is 45 degrees.

In some cases the first friction pivot provides freedom of rotation, such that shaving pressure will rotate the head in the pivot, and the range of motion is limited to substantially fifteen degrees in each direction of rotation from a first position with the head disposed substantially at a right angle to the first axis. In other cases the first friction pivot provides rotary stability in use, such that shaving pressure will not rotate the head in the pivot, and the range of motion is limited to substantially thirty degrees in each direction of rotation from a first position with the head disposed substantially at a right angle to the first axis.

In preferred embodiments the second pivot provides rotary stability in use, such that shaving pressure will not rotate the handle portion relative to one another, and the range of motion is up to 270 degrees between axes of the handle portions joined at pivot 503. In some embodiments the first and second handles are of substantially the same length. IN other embodiments the first handle may be shorter than the second handle.

In embodiments of the invention, taught in enabling detail below, for the first time a safety razor is provided that is truly comfortable for shaving in opposite directions, and allows a user to adjust both the rotation relationship of the head with the handle, and also offset.

In embodiments of the invention described in enabling detail below a safety razor is provided with maximum adjustability for shaving comfort and convenience, allowing, for example, shaving in both directions.

### BRIEF DESCRIPTION OF THE DRAWING FIGURES

FIG. 1a, labeled prior art, is an elevation view of a conventional double-sided safety razor in a downward stroke.

FIG. 1b is an elevation view of the safety razor of FIG. 1a in an upward stroke.

FIG. 2a is a broken side view of the upper portion of an opposite-directional razor according to a preferred embodiment of the present invention.

FIG. 2b is a broken perspective view of the front of the razor of FIG. 2a.

FIG. 3a is an elevation view of the razor of FIG. 2a in a downward stroke.

FIG. 3b is an elevation view of the razor of FIG. 3a in an upward stroke.

FIGS. 4a and 4b describe a razor in another embodiment of the invention.

FIG. 5 is an elevation view of a safety razor according to an alternative embodiment of the present invention.

### DESCRIPTION OF THE PREFERRED EMBODIMENTS

As described in the background section, conventional safety razors vary greatly in design and appearance, and may have a single blade or a plurality of cutting blades, typically with cutting edges all facing in the same direction. Many razors common in the art have the cutting blades mounted into a disposable cartridge that is manufactured of universal size and shape, designed to clip or slide onto the top portion of a non-disposable handle. Other razors common in the art are manufactured with the head portion containing the cutting blade or blades permanently attached to the handle and designed to be disposable as a whole.

One undesirable trait that is common to all cartridge-style razors of the type described above is that the cutting edge of the blade or blades is located on one side of the head portion or cartridge. A blade or combination of blades positioned on the razor head or cartridge in such a way poses a significant problem for users wishing to quickly and easily change to an opposite direction of stroke while maintaining a comfortable angle of shaving, which can vary greatly, from perhaps less than 30 degrees to more than 60 degrees, without releasing the handle or holding the wrist and arm in an uncomfortable and awkward position. Achieving a bi-directional stroke with the cutting blades at a workable angle, and without the need for releasing and repositioning the grip on the handle, requires a razor having a head portion with two opposing sides, each having one or more cutting edges.

As described earlier, a conventional double-edges razor having such a head portion permanently attached to the handle and utilizing a replaceable blade with a cutting edge on both opposing sides is known. The double-edges razor, later eclipsed by the introduction of inexpensive injector cartridge type single-sided razors as previously mentioned, was developed with a mechanical apparatus having two hinged lids actuated by a turning knob at the bottom of the handle that opens and closes the lids to allow access to the compartment holding the double-edged replaceable blade. Once the lids are opened the double-edged blade can be placed within a holder under the lids and secured when the lids are closed tight. Once the lids are tightly closed a slight downward bend is applied by the blade-holding apparatus to the blade on both sides near the cutting edge, providing a means to acquire a comfortable and workable blade-to-skin angle.

An advantage to such a double-edged safety razor is that it allows the user to switch the stroke from one direction to the other without releasing the grip. A remaining problem, however, is that due to the orientation between the handle and cutting edges in the head, an upward stroke requires that the razor be held at an extreme angle in relation to the surface being shaved. To achieve this angle while adhering to the proper angle of the blade's cutting edge, the user must hold the wrist significantly bent in an uncomfortable position with the arm and elbow also held in a very cumbersome and awkward position.

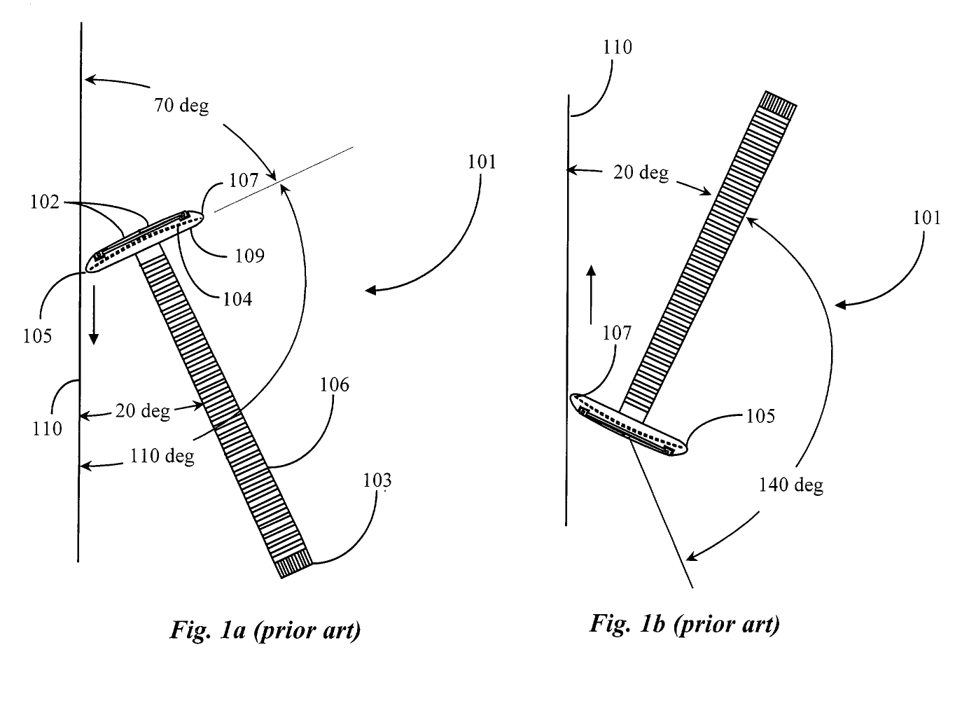

FIG. 1a, labeled prior art, is an elevation view of a conventional double-sided safety razor in a downward stroke. For reasons of simplicity many details of the razor depicted are not shown, as the purpose of this view is only to illustrate the relationship between the angles of the razor head portion and the handle, and between the blade's cutting edges and the shaving surface. Safety razor 101 is a conventional double-edged, hinged-lid shaving implement known in prior art, similar to that which has been previously described.

In FIG. 1a blade 104 is shown secured with a downward bend within a head portion 109, blade 104 having a cutting edge 105 and a cutting edge 107 located on opposite sides of head portion 109. Hinged lids 102, opened and closed by a mechanical apparatus (not shown) within razor 101 and actuated by turning knob 103, located at the bottom of handle 106, clockwise or counterclockwise providing access to the blade holding area as well as providing a means for clamping down and securing blade 104. Surface 110 is provided in this view as a representation of a shaving surface, such as a portion of a user's skin surface, to show the relationship of angles between itself, razor 101 and cutting edges 105 and 107.

To achieve a comfortable and workable cutting action the angle between the shaving surface and the cutting edge of a blade can vary widely, typically between perhaps 30 degrees and perhaps 65 degrees. Cutting edges 105 and 107 of blade 104 are angled downward (toward the handle) by the clamping method previously described, to an angle of approximately 10 degrees in relation to the perpendicular head portion 109. In order to achieve a preferred shaving angle of 60 degrees between cutting edge 105 and surface 110, shaver 101 is positioned such that an angle between the surface to be shaved and a plane perpendicular to the handle of the apparatus is 70 degrees, as shown. In this orientation, the angle between the axis of the handle and surface 110 is 20 degrees as is also shown in FIG. 1a.

FIG. 1b is an elevation view of the conventional safety razor of FIG. 1a positioned for an upward stroke with the opposite blade and cutting edge 107 positioned at an angle of 60 degrees with surface 110. In order to achieve the preferred shaving angle of 60 degrees between cutting edge 105 and surface 110 during an upward stroke as indicated, the handle of shaver 101 must be rotated in a plane defined by the axis handle by 130 degrees from the position during a downward stroke as in FIG. 1a. In order for a user to hold a razor such as razor 101 properly by the handle at such an angle during and upward stroke a user must hold arm and elbow up, bending the wrist significantly downward at an angle that is both awkward and uncomfortable.

Using the razor of FIGS. 1a and 1b, wherein the blade cutting edges point somewhat toward the handle on each side, in this example by 10 degrees, the angle through which one has to rotate the handle to shave in the opposite direction with the opposite blade edge is also a function of the comfortable shaving angle. For example, if the angle of the cutting edge to the skin surface is to be 30 degrees, and the original downward angle of the cutting edges on each side is 10 degrees, than the angle through which one needs to rotate the handle to shave in the opposite direction with the opposite blade is 80 degrees.

It is the object of the present invention to provide a method and apparatus enabling a user to easily switch between an upward and downward contiguous stroke without the need to release the grip or hold arm, elbow and wrist at uncomfortable positions, or to have to rotate the handle of the razor through a significant flat angle.

It is the inventor's opinion that a shaving angle of less than 30 degrees is likely not too practical, and examples for the prior art will thus be limited to a minimum of 30 degrees for the shaving angle.

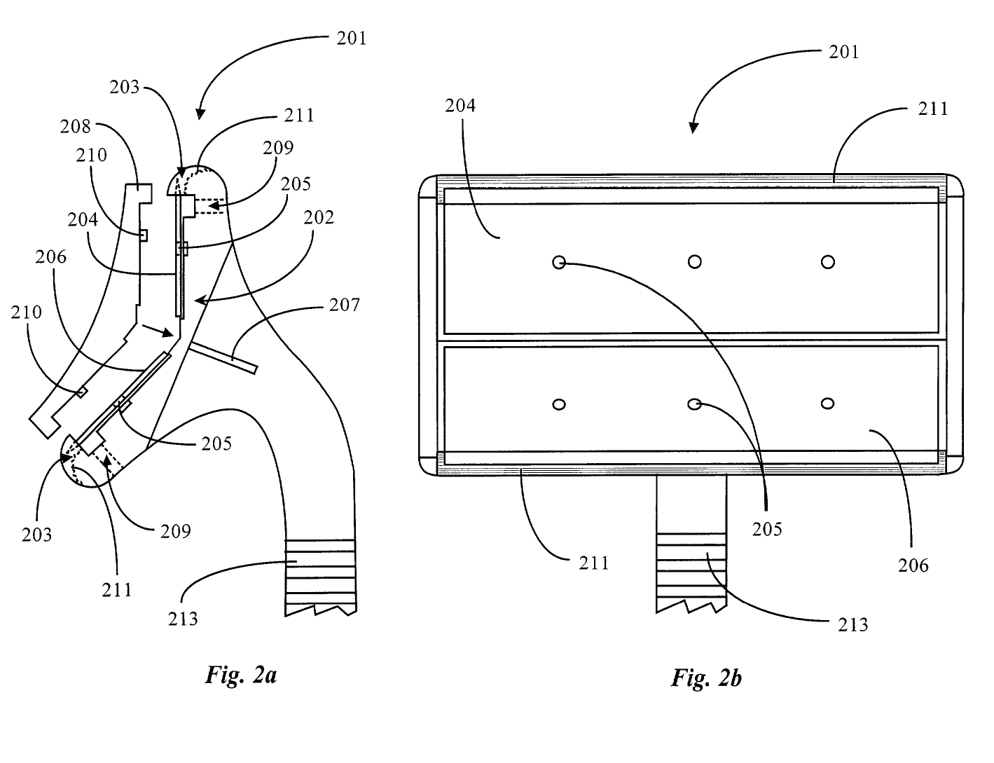

FIG. 2a is a partially exploded side view of the upper portion of a bi-directional razor 201 according to a preferred embodiment of the present invention. FIG. 2b is a frontal view at 90 degrees from the viewpoint of FIG. 1a. and from the side opposite the handle. Razor 201 is provided having a head portion 202 with dual opposite-facing ends facing away from center at an included angle of approximately 150 degrees. This angle of 150 degrees is 40 degrees less than the analogous included angle of the conventional double-edged razor shown in FIGS. 1a and 1b, where the analogous angle is 200 degrees (180 degrees plus the 10 degree bend imposed in the blade for each cutting edge).

In FIGS. 2a and 2b cutting blades 204 and 206 are shown as flat blades placed on flat areas provided on the front side of head portion 202. Cover 208 is provided as an apparatus for securing blades 204 and 206 to head portion 202. Extensions 210 on the underside of cover 208 are located to coincide with holes 205 of blades 204 and 205 and matching receiving recesses within head portion 202. In this manner once cover 208 is placed upon the mounted blades 204 and 206, and is secured to head portion 202 by various conventional means, such as heat molding, adhesive, or other attachment process, blades 204 and 205 are securely fastened in the proper location.

A conventional method is used for the passage of cut hair and shaving cream or other shaving lubricant during either the upward or downward stroke in shaving. During a stroke shaving lubricant passes through a passage 203 located on the tip of each edge of head portion 202, and out through passages 209. Such arrangement is known in other safety razors. Guards 211, also located on both edges, are conventional in the current art as well, providing protection to the skin from cuts or nicks during shaving. Braces 207, also conventional, are shown in this embodiment providing structural support to the interface between head portion 202 and a conventional handle 213, and are located on either side of handle 213. What is entirely new and non-obvious in razor 201 is the inclusion of a blade arrangement in which the cutting edges face outward in opposite directions forming an included angle of less than 180 degrees facing away from the handle portion of the razor, which greatly facilitates the use of the razor for alternating strokes placing the opposite cutting edges in position for cutting, without as extensive a change in the grip or arm and hand positions as is necessary with razors of the prior art. Because of the included angle of less than 180 degrees the handle of the razor need not by rotated in a flat plane as much as would be required for any double-edged, opposite facing razor in the prior art.

Referring now to FIG. 2b, cover 208 is not shown in this view. The position of blades 204 and 206 can be seen in their proper location with the cutting edges protruding slightly over guards 211. The orientation of holes 205 within blades 204 and 206 can also be clearly seen.

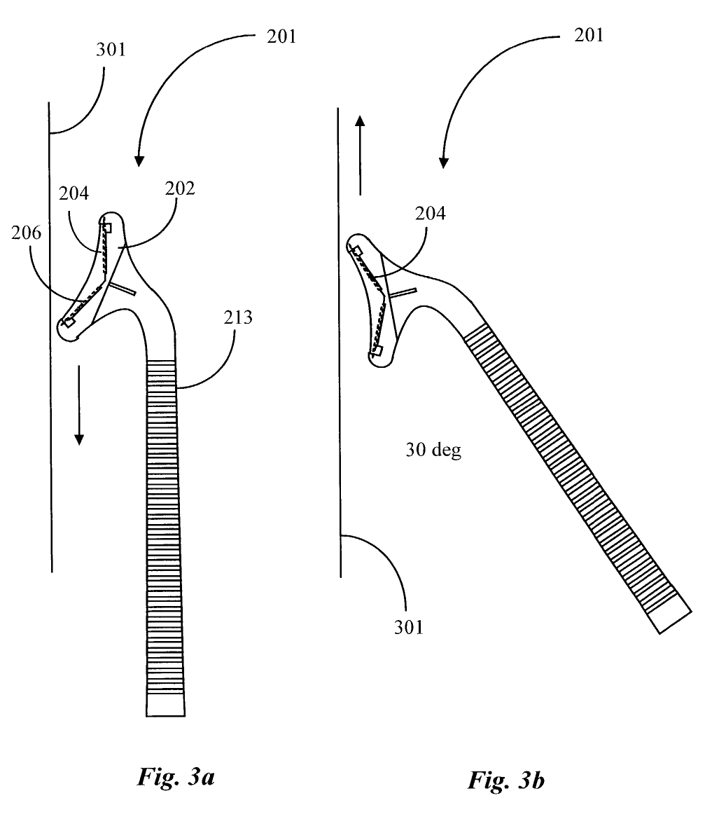

FIG. 3a is an elevation view of razor 201 of FIG. 2a in a downward stroke. Surface 301, analogous to surface 110 of FIGS. 1a and 1b, is also shown in this view as a representation of a shaving surface to show the relationship of angles between the shaving surface, handle 213 and the cutting edge of the lower blade 206. Due to the included angle of approximately 150 degrees described above with the aid of FIGS. 2a and 2b, razor 201 provides the average user a means for easily achieving a desirable shaving angle between blade 206 and surface 301 during the downward stroke, while holding handle 213 in a comfortable position roughly parallel to the surface 301. The angle of blade 206 to surface 301 in this view is about 30 degrees, but can be easily changed simply by altering the angle of handle 213 with surface 301. FIG. 3a shows the cutting edge of blade 204 facing directly upward parallel to surface 301, and parallel to the axis of handle 213. Attention is also drawn to the fact that the drawings are not meant to be engineering drawings to scale, and the specification of the angles and any dimensions described in the text is meant to be definitive.

FIG. 3b is an elevation view of razor 201 of FIG. 3a in an upward stroke. As can be seen in this view the included angle incorporated into razor 201 provides an advantage over razors from prior and conventional art in that during the upward stroke, a desired cutting angle for upper blade 204 in the upward stroke direction, is easily achieved by rotating razor 201 only 30 degrees from the vertical position. Compare this with the necessary rotation of 80 degrees necessary for the case of the conventional double-edges razor with a shaving angle of 30 degrees, as described above.

The greatly reduced rotation angle required in this embodiment to achieve a comfortable and effective cutting angle during an upward stroke provides the average user much greater comfort, eliminating the need to hold the arm, elbow and wrist in uncomfortable, tiring and awkward positions as is required by a conventional double-edged razor. Another advantage provided in this embodiment is the elimination of the need for a user to release the grip from the handle when switching between upward and downward strokes, as is the case while shaving with a conventional razor with only one cutting edge. A user saves much time when shaving in this manner, particularly when shaving large areas such as the legs.

It is certainly not required in embodiments of the present invention that the angular relationships be such that the axis of the handle be parallel with the shaving surface to achieve a comfortable shaving angle. The handle may relate to the head differently than shown, without altering the required flat rotation of the handle to achieve the same shaving angle for an upstroke. For example, if the head stayed in the same position as shown in FIG. 3a, but the handle described an angle of 20 degrees with surface 301, it would still be necessary to rotate the handle through a flat plane of just 30 degrees to get the same shaving angle for blade 204.

In other embodiments of the present invention a double-edged razor can have a head portion with opposing cutting sides similar to those of razor 201 of FIG. 2a but with one being positioned 180 degrees opposite to the other, and having a swivel mechanism incorporated into each cutting side individually. Such swivel mechanisms can have stops or notches included within to position and hold each cutting edge at the proper cutting angle during friction encountered in either an upward or downward stroke. In other alternative embodiments of the present invention a swivel mechanism can be used as the interface between the handle of the razor and a head portion with dual cutting edges rigidly positioned 180 degrees from each other. Such a swivel mechanism in this embodiment can have a stop or notch incorporated similarly that previously described to also hold the stationary cutting sides at the proper angle during either an upward or downward stroke.

In still another embodiment of the present invention there may be a single blade instead of the two blades illustrated above, and the less-than-180-degree included angle may be achieved by placing and fastening element 208 to the head (see FIG. 2a), bending the single blade into the desired orientation.

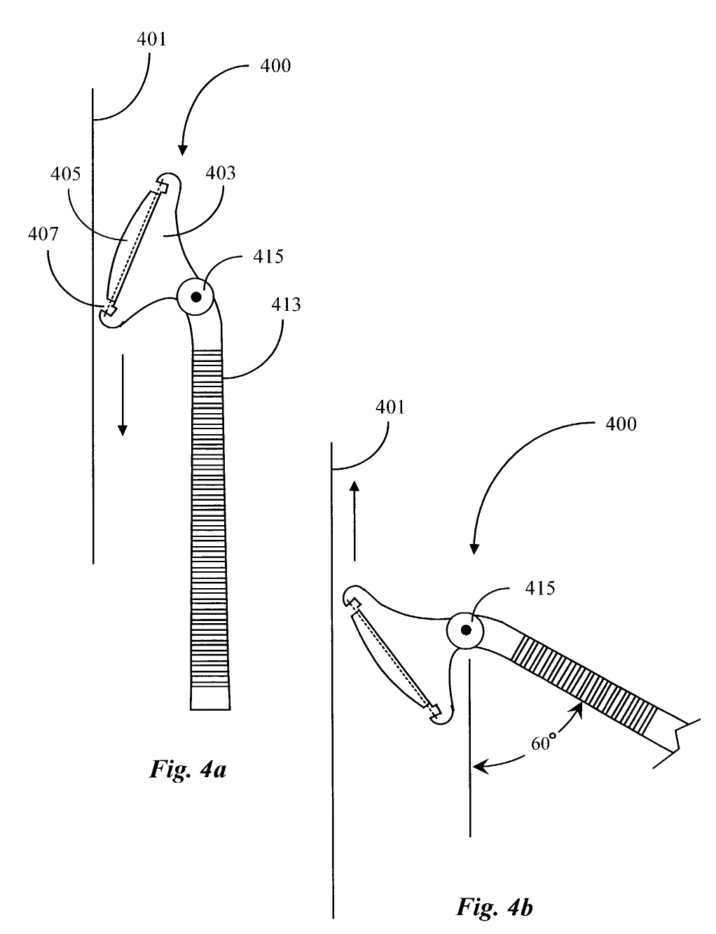

FIGS. 4a and 4b illustrate still another embodiment of the present invention wherein a double-edged razor 400 has a blade 407 held in place by a cover 405 in a head 403 connected to a handle 413. The blade is mounted in this embodiment so the two cutting edges face exactly opposite, 180 degrees, from one another. FIG. 3a shows shaving in a downward direction with a shaving angle of 30 degrees, and FIG. 4b shows shaving in an upward direction with a shaving angle of 30 degrees. The necessary flat rotation of handle 413 in this instance is 60 degrees, which is still less than the 80 degrees minimum of the prior art situation.

In a further embodiment a pivot 415 is provided, which allows a user to adjust the angle of the handle to the head to suit different purposes and different preferences. For example, to shave one's face, this angle may best be a first angle, and to shave one's legs a different angle may be preferable. The pivot may be implemented in many different ways, but in a preferred embodiment the pivot is implemented to have an amount of friction to rotate such that the normal forces on the razor will not rotate the pivot, but one may easily rotate the pivot by grasping the head with one hand and the handle with the other, and rotating.

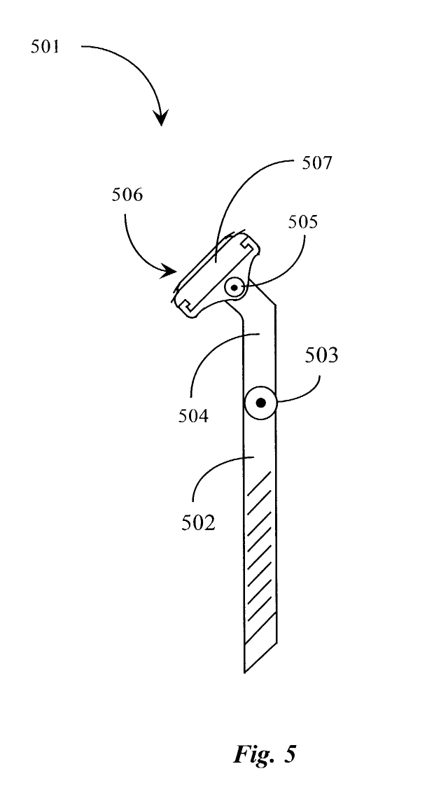

In yet another embodiment of the invention a safety razor is provided having multiple pivot points and a compound handle, as is shown in FIG. 5. In FIG. 5 razor 501 has a rigid first handle portion 502, a first pivot 503 connecting handle 502 to a second rigid handle portion 504. At the end of handle 504 away from pivot 503 a second pivot is implemented, joining handle 504 to a shaving head 506. Second handle portion 504 is an angled handle portion, shown in this view as defining an angle of about forty-five degrees. Also in FIG. 5 a first part of handle portion 504, adjacent to and connecting to pivot 503, is longer than a second part terminating at pivot 505. In various embodiments this angle may be different than the about forty-five degrees shown, as small as fifteen degrees in some cases, and as much as ninety degrees in other cases.

Pivot 503 is implemented in a preferred embodiment as a friction pivot, such that the angle of handle portion 502 to handle portion 504 may be easily adjusted by a user by grasping the opposing handle portions and applying a rotary moment to the pivot, the friction being such that, once adjusted, the light pressure of shaving with the adjusted handle will not be sufficient to cause the angle to change. Further, in a preferred embodiment, the range of adjustable rotation is substantial, allowing the user to rotate the handle portions relative to one another as much as 270 degrees.

Pivot 505 in a preferred embodiment is more free than pivot 503, such that head 506 may rotate around pivot 505 freely in shaving, and by the rotational forces imposed by shaving action. Pivot 505 is, however, constrained in a preferred embodiment to rotate no more than about fifteen degrees in either direction from the position shown, wherein head 506 is disposed at ninety degrees to the axis of the second part of handle portion 504. In some alternative embodiments pivot 505 has more friction, of the order of pivot 503, and may also have greater range of motion, as much as thirty degrees in each direction, for a maximum sixty degrees.

Head 506 in the embodiment shown in FIG. 5 is configured to accept blade modules 507 inserted in a pre-configured slot from either side of the head, as is well-known in the art. The blade modules can be of any known sort, having one, two or three blades facing each direction, and of a variety of blade angles to the head.

The relative lengths of the handle portions in razor 501 may vary considerably, as may the freedom of movement of the pivots, and models may be provided for many different sorts of exchangeable blade heads. In one embodiment a fixed blade head as part of head 506 may be provided, as a throw-away razor, rather than being implemented for exchanging blade heads.

It will be apparent to one with ordinary skill that the method and apparatus of the present invention may be practiced in many different types of implements, and therefore may be modified in dimensional size and shape to fit many user situations. It is the object of the present invention to provide new and novel method and apparatus in many varying embodiments, enabling the average user to shave in a much more comfortable manner while saving much time and effort. The size, shape, materials and method of manufacture may vary greatly in different embodiments utilizing the improved method and apparatus of the present invention as described without departing from the overall spirit and scope of the invention. For example, any and all combinations of cutting blades may be used as can the method of securing blades to the head portion, location of pivot points if any, and so on.

In various embodiments of the invention any one or all of the following features may be present:

1. The handle may include one or more rotating parts.

2. The shaving head may hold any number of blades facing in either one or opposite directions.

3. The shaving head can be either fixed or pivoting, and there may be interchangeable blade modules.

4. The handle and the shaving head can also be of the disposable type.

5. The handle may be straight and/or angular (the angular handle may be angled to any degree which allows the invention to be functional).

6. The shaving head may be allowed to pivot in a forward or a backward motion as the accepted norm today—further, it may pivot to a higher or a lesser degree.

7. All of the components may be larger or smaller than shown in the drawings or the accepted norm.

8. The handle may rotate in either direction.

9. The components may also position the shaving head in a vertical position to the ground.

10. The razor in some embodiments of the invention can fold up neatly and compactly, as a travel shaver.

11. There may be any number of rotating parts to the handle and-or the shaving head (when the rotating point(s) of the handle is lowered, the top and bottom portion of the handle will meet, and further, the shaving head will extend beyond the handle(s) and the pivot action of the shaving head can angle beyond the handle).

The method and apparatus of the present invention should be afforded the broadest possible scope. The spirit and scope of the present invention should be limited only by the claims that follow.

What is claimed is:

1. A safety razor comprising:
a head holding a blade system;
a first friction pivot at the head to a first end of a first handle; and
a second friction pivot at a second end of the first handle opposite the first end to one end of a second handle;
characterized in that, with the second handle as a handle for holding the razor in use, the head may be both angled and offset relative to the second handle.

2. The safety razor of claim 1 wherein the head is configured to accept interchangeable blade modules of any number of blades facing in either one or opposite directions.

3. The safety razor of claim 1 wherein the first handle has a first part with a first axis and a second part with a second axis, and the first and second axes form a fixed angle.

4. The safety razor of claim 3 wherein the fixed angle is between 15 and 60 degrees inclusively.

5. The safety razor of claim 4 wherein the fixed angle is 45 degrees.

6. The safety razor of claim 1 wherein the first friction pivot provides freedom of rotation, such that shaving pressure will rotate the head in the pivot, and the range of motion is limited to substantially fifteen degrees in each direction of rotation from a first position with the head disposed substantially at a right angle to the first axis.

7. The safety razor of claim 1 wherein the first friction pivot provides rotary stability in use, such that shaving pressure will not rotate the head in the pivot, and the range of motion is limited to substantially thirty degrees in each direction of rotation from a first position with the head disposed substantially at a right angle to the first axis.

8. The safety razor of claim 1 wherein the second pivot provides rotary stability in use, such that shaving pressure will not rotate the handle portion relative to one another, and the range of motion is up to 270 degrees between axes of the handle portions joined at pivot 503.
